(19) United States
(12) Patent Application Publication
(10) Pub. No.: US 2003/0233247 A1
(43) Pub. Date: Dec. 18, 2003

(54) System and method for reviewing data in a mobile terminal

(76) Inventors: Fu-Yu Liu, Taipei (TW); Yi-Nan Li, Taipei (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/308,769

(22) Filed: Dec. 2, 2002

(30) Foreign Application Priority Data
Jun. 13, 2002 (TW) 91112869

(51) Int. Cl. G06F 17/60

(52) U.S. Cl. 705/1; 455/422.1

(57) ABSTRACT

A system for reviewing data in a mobile terminal (109) includes a pending event storing module (306), and a client data storing module (305). The pending event storing module connects with the client data storing module, and accesses data stored in the client data storing module. The pending event storing module includes a data sheet for storing pending events (401), a data sheet for storing commercial activities (402), a data sheet for recording data to-be-prepared (404), and a data reviewing interface (405). The data reviewing interface links with the data sheet for recording data to-be-prepared and the data sheet for storing commercial activities, and displays data stored in the data sheet for recording data to-be-prepared, the data sheet for storing commercial activities, the data sheet for storing pending events, and the client data storing module. A related method for reviewing information is also disclosed.

### BACKGROUND OF THE INVENTION

1. Field of the Invention

The present invention relates to a system and method for reviewing data in mobile commerce, and especially to a system and method for reviewing data in a mobile terminal for execution of mobile commerce.

2. Background of the Invention

Traditional communication means such as letters, telephones, and faxes are used in a typical conventional business model. In such model, many people waste time on data collection and information transfer. Human error leads to serious mistakes being made, which can cause huge damage to an enterprise. There are also other difficulties including providing adequate technical support, high costs, and low customer satisfaction when mistakes occur.

The development of the Internet has given rise to the electronic business model, which relies on Electronic Data Interchange (EDI). Electronic and digitized information is transferred faster and more accurately. The electronic business model breaks through conventional limitations of time and space, enhances the efficiency of running an enterprise, reduces costs, provides more information, and gives the enterprise more business opportunities. The electronic business model allows clients to easily acquire information on merchandise and on an enterprise, and to contact the enterprise instantaneously via the Internet. Further, data collection and integration is much easier.

U.S. Patent Application Pub. No. 2001/0042020 discloses a method for increasing electronic business. An enterprise uses a computer to show its clients data on merchandise. The clients use computers to send purchase requests to the enterprise via the Internet. Finally, the enterprise and the clients reach settled purchase agreements. However, in this method, there is no direct communication between the enterprise and each client. The clients cannot easily obtain more information about the enterprise and its merchandise, and the enterprise cannot easily obtain more information about clients and their requests.

Accordingly, a new business model is desired to make communication between enterprises and clients faster and more accurate, to strengthen technical support, and to yield more client satisfaction. In this business model, sales representatives of the enterprise each carry a mobile terminal storing ample information for execution of commercial activities. This is preferable to carrying excessive paperwork.

### SUMMARY OF THE INVENTION

Accordingly, one objective of the present invention is to provide a system for conveniently reviewing data in a mobile terminal for execution of mobile commerce.

Another objective of the present invention is to provide a method for conveniently reviewing data in a mobile terminal for execution of mobile commerce.

In order to achieve the first above-mentioned objective, the present invention provides a system for reviewing data in a mobile terminal. The mobile terminal of the system comprises a pending event storing module, a client data storing module, and an issued information storing module. The pending event storing module connects with the client data storing module, and accesses data stored in the client data storing module. The pending event storing module comprises a data sheet for storing pending events, a data sheet for storing commercial activities, a data sheet for recording data to-be-prepared, and a data reviewing interface. The data reviewing interface links with the data sheet for recording data to-be-prepared and the data sheet for storing commercial activities, and displays data stored in the data sheet for recording data to-be-prepared, the data sheet for storing commercial activities, the data sheet for storing pending events, the client data storing module and the issued information storing module.

In order to achieve the second above-mentioned objective, a method for reviewing data in a mobile terminal in accordance with the present invention comprises the steps of: displaying a data sheet for storing recording data to-be-prepared; displaying a data sheet for storing pending events; displaying a data sheet for storing commercial activities; ticking off one or more selected items in the data sheets via a data reviewing interface; adding items ticked off in the data sheet for storing commercial activities and the data sheet for storing pending events to the data sheet for recording data to-be-prepared; and deleting items ticked off in the data sheet for recording data to-be-prepared.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of a system for reviewing data in a mobile terminal in accordance with a preferred embodiment of the present invention, the system comprising a database server, a mobile commerce server and at least one mobile terminal;

FIG. 2 is a schematic diagram of detailed infrastructure of the database server of the system of FIG. 1, and shows data communication between the database server, the mobile commerce server and one mobile terminal;

FIG. 3 is a schematic block diagram of function modules of one mobile terminal of the system of FIG. 1;

FIG. 4 is a schematic block diagram showing details of and data communication between certain of the function modules of the mobile terminal schematically illustrated in FIG. 3;

FIG. 5 is a flowchart of executing mobile commerce in accordance with a preferred embodiment of the present invention; and

FIG. 6 is a flowchart of details of one step of FIG. 5, namely reviewing downloaded data.

### DETAILED DESCRIPTION OF PREFERRED EMBODIMENTS OF THE INVENTION

Reference will now be made to the drawings to describe the present invention in detail.

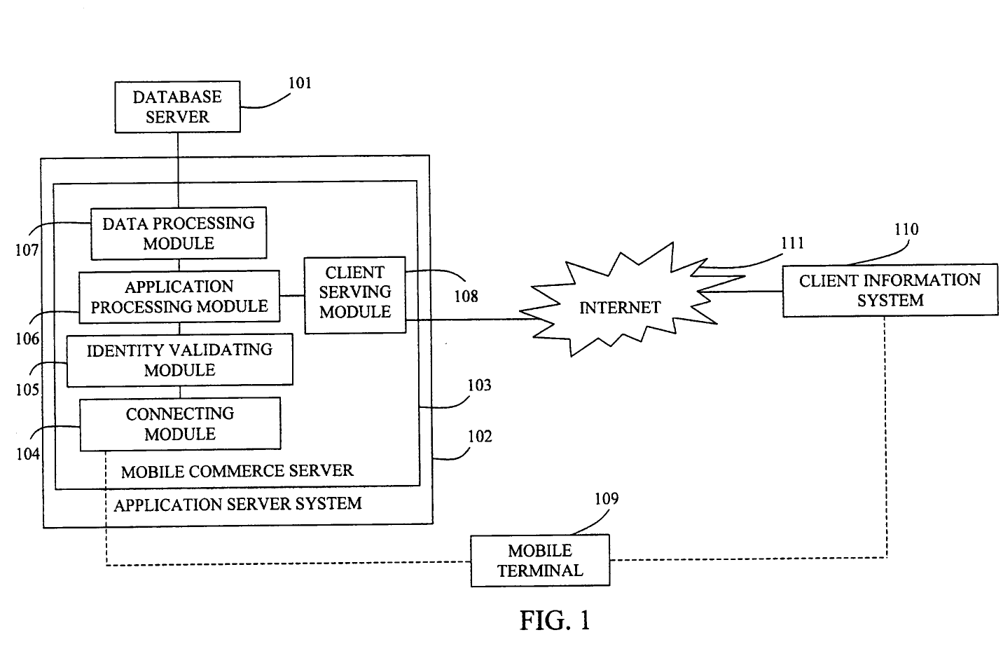

FIG. 1 is a schematic diagram of a system for reviewing data in a mobile terminal in accordance with a preferred embodiment of the present invention. The system for reviewing data in a mobile terminal comprises a three-tier information system. The three-tier information system comprises a database server 101 (the bottom tier), an application server system 102 (the middle tier), and a plurality of distributed terminal workstations 109 (the top tier, only one shown). The application server system 102 of the preferred embodiment comprises a mobile commerce server 103. Each terminal workstation 109 of the preferred embodiment is a mobile terminal 109, which can be a Personal Digital Assistant (PDA), a pocket personal computer (PC), a laptop computer, a palmtop computer, a smart phone or a notebook computer. A client information system 110 connects with each of the mobile terminals 109 via a cable, infrared signals, or wireless communications. Each mobile terminal 109 connects with the mobile commerce server 103 via a cable, infrared signals, or wireless communications. The mobile commerce server 103 connects with the database server 101, and is used for creating business schedules in accordance with data stored in the database server 101. The mobile terminal 109 downloads a business schedule from the mobile commerce server 103, for assisting execution of commercial activities. The mobile terminal 109 shows steps of required commercial activities in accordance with the business schedule, records data on execution of commercial activities, and uploads data on transactions and on execution of commercial activities for updating of data stored in the client information system 110.

The mobile commerce server 103 comprises a connecting module 104, an identity validating module 105, an application processing module 106, a data processing module 107, and a client serving module 108. The connecting module 104 connects with the mobile terminal 109, and is used for transferring data between the mobile terminal 109 and the mobile commerce server 103. The identity validating module 105 checks identities of personnel such as sales representatives, and distributes various business schedules to various sales representatives. The application processing module 106 creates business schedules for every sales representative in accordance with data stored in the database server 101, and updates data stored in the database server 101 in accordance with data sent from the mobile terminal 109. The data processing module 107 connects with the database server 101, and transfers data between the database server 101 and the mobile commerce server 103. The client serving module 108 connects with the client information system 110 via the Internet 111. The client serving module 108 sends information on mobile commerce to clients, and receives data on cooperating with clients and data on requirements of clients.

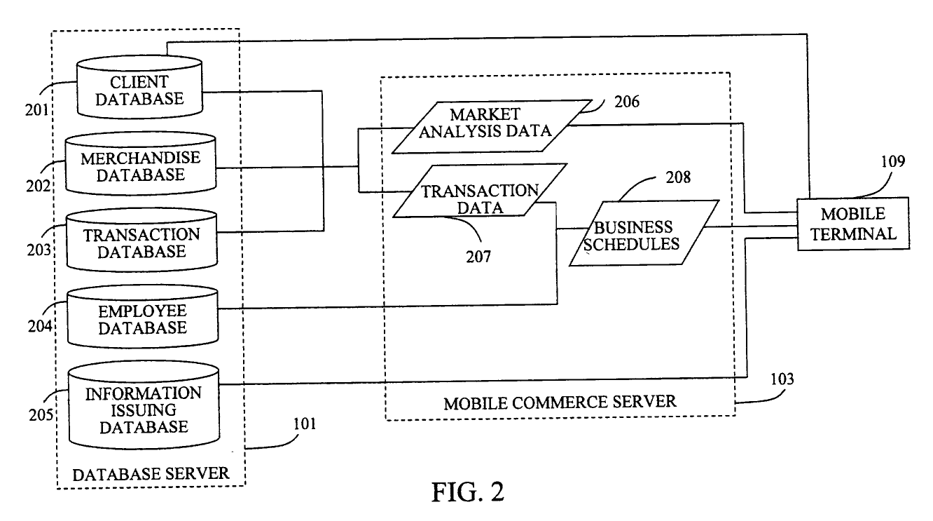

FIG. 2 is a schematic diagram of detailed infrastructure of the database server 101, and shows data communication between the database server 101, the mobile commerce server 103 and one mobile terminal 109. The database server 101 is a central database of an entire enterprise. The database server 101 comprises: a client database 201 for storing data on clients; a merchandise database 202 for storing data on merchandise sold by the enterprise; a transaction database 203 for storing transaction data on the enterprise; an employee database 204 for storing employee data including data on all sales representatives; and an information issuing database 205 for storing information issued by the enterprise. The application processing module 106 of the mobile commerce server 103 integrates data stored in the client database 201, data stored in the merchandise database 202, and data stored in the transaction database 203 to create transaction data 207 and market analysis data 206. The transaction data 207 and the market analysis data 206 are stored in the mobile commerce server 103. The transaction data 207 and data stored in the employee database 204 are processed by the application processing module 106 to create business schedules 208 for sales representatives. The business schedules 208 are stored in the mobile commerce server 103. During the process of downloading data from the mobile commerce server 103, the business schedules 208, the market analysis data 206, data stored in the client database 201, and data stored in the information issuing database 205 are transferred to the mobile terminal 109 via the connecting module 104 of the mobile commerce server 103.

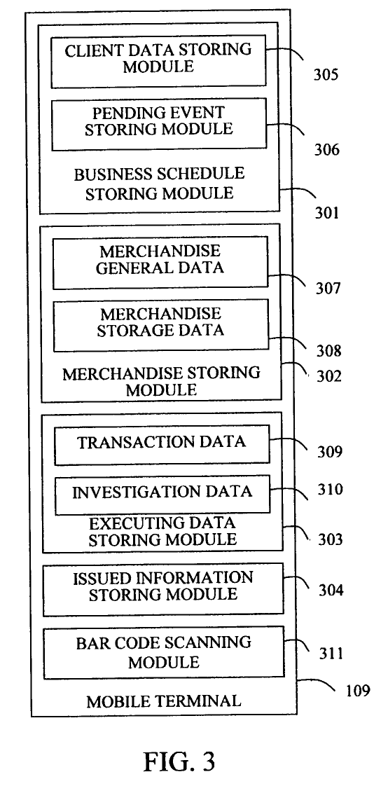

FIG. 3 is a schematic block diagram of function modules of one mobile terminal 109. The mobile terminal 109 comprises: a business schedule storing module 301 which is used to record work flow and clients that a sales representative visits; a merchandise storing module 302 which is used to store all merchandise information on the enterprise as a reference for the sales representative to inquire of; an executing data storing module 303 which is used to record data on execution of commercial activities; an issued information storing module 304 which is used to store information on the enterprise's current news, merchandise shortage notes, and newly promoted products; and a bar code scanning module 311 which is used to scan and identify various clients' bar codes which respectively represent various clients.

The business schedule storing module 301 comprises a client data storing module 305, and a pending event storing module 306. The client data storing module 305 stores commercial activities information on clients, including client basic data such as name, address and phone number, client ordering data, and accounts receivable. The pending event storing module 306 is used to remind the sales representative of matters that need to be attended to. For instance, such matters may be orders that need conducting, collection of accounts receivable, and market investigation. The merchandise storing module 302 comprises merchandise general data 307 and merchandise storage data 308. The merchandise general data 307 includes basic merchandise data such as name, serial number and specification, merchandise price data and key merchandise data. The merchandise storage data 308 includes corresponding merchandise inventory volume and distribution information. The executing data storing module 303 stores transaction data 309 and investigation data 310. The information in the executing data storing module 303 is sent to the mobile commerce server 103, and is processed by the application processing module 106. The information in the database server 101 is updated accordingly.

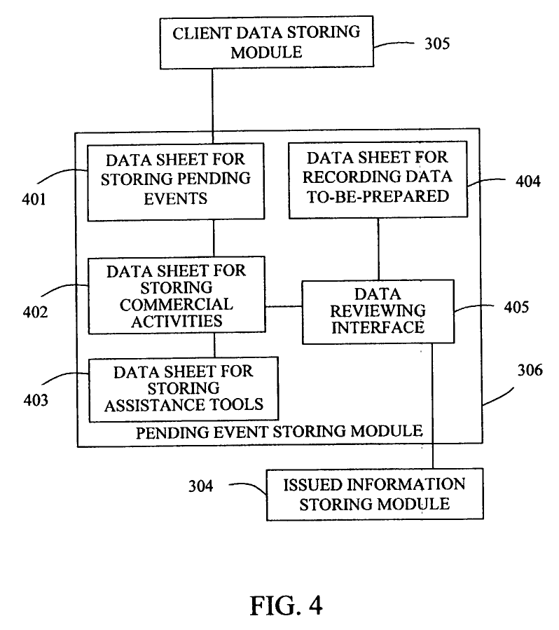

FIG. 4 is a schematic block diagram showing details of and data communication between certain of the function modules of the mobile terminal 109 schematically illustrated in FIG. 3. The pending event storing module 306 comprises a data sheet for storing pending events 401, a data sheet for storing commercial activities 402, a data sheet for storing assistance tools 403, a data sheet for recording data to-be-prepared 404, and a data reviewing interface 405. The data reviewing interface 405 is a unique interface for data reviewing. Data stored in the data sheet for storing pending events 401, the data sheet for storing commercial activities 402, the data sheet for storing assistance tools 403, and the data sheet for recording data to-be-prepared 404 are displayed in the data reviewing interface 405. The data reviewing interface 405 provides functions of searching, next, and end reviewing. The sales representatives can process data stored in the data sheets via these functions. The data reviewing interface 405 is also linked with the issued information storing module 304, and can display information obtained therefrom.

The data sheet for storing pending events 401 is used for storing events to be executed and corresponding data during execution of the events. Such events include, for example, collecting accounts receivable, market investigation, and conducting sales orders. The data sheet for storing pending events 401 connects with the client data storing module 305 to access corresponding client data stored therein. The data sheet for storing commercial activities 402 stores data on a sequence of commercial activities. A summary of documents required, and of assistance tools required for assisting execution of the commercial activities, are each stored in the data sheet for storing commercial activities 402 as appendixes of corresponding commercial activities. Documents required may include hardcopy documents required and electronic documents required. The data sheet for storing assistance tools 403 stores data on tools for assisting sales, such as advertising pictures, posters, and pictures of merchandise. The data sheet for recording data to-be-prepared 404 stores a summary of unprepared data for use during data reviewing. Such data typically comprise electronic files, and paperwork such as bills, contracts and the like. The electronic files can be stored in the mobile terminal 109. If the sales representative finds unprepared data, he/she can tick off the unprepared items, and the data reviewing interface 405 adds the items to the data sheet for recording data to-be-prepared 404. When a piece of unprepared data is subsequently prepared, the sales representative can tick off the corresponding item in the data sheet for recording data to-be-prepared 404, whereupon the data reviewing interface 405 deletes the item from the data sheet for recording data to-be-prepared 404. The sales representative can thus proceed to prepare all pieces of unprepared data until the data sheet for recording data to-be-prepared 404 is emptied. The process of preparing data may include downloading of electronic documents from the mobile commerce server 103, and manual preparation of paperwork such as bills, contracts and the like.

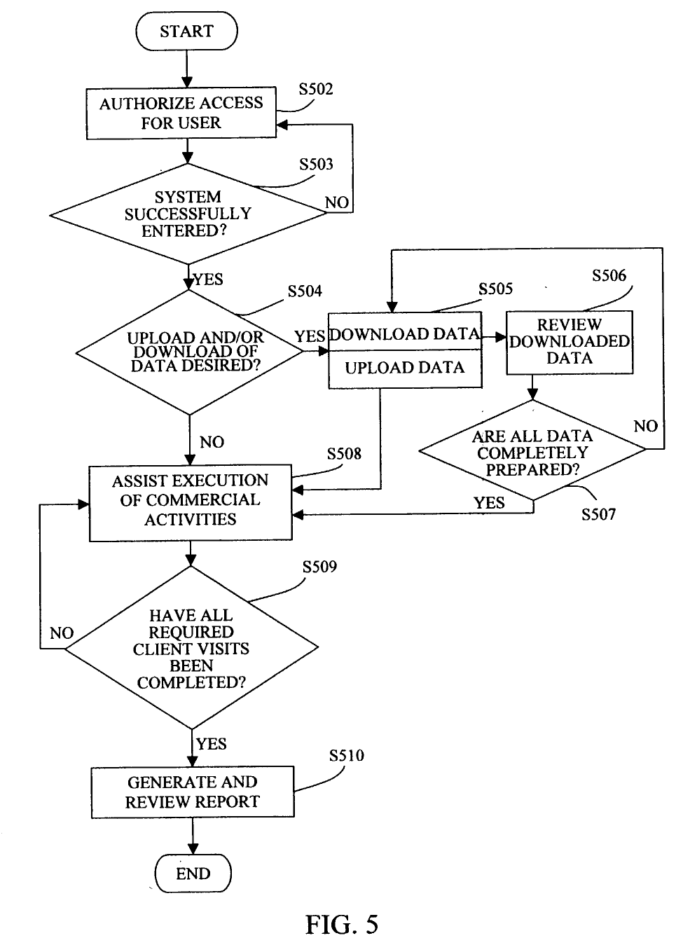

FIG. 5 is a flowchart of execution of mobile commerce in accordance with a preferred embodiment of the present invention. Firstly, in step S502, before a user enters the system, the mobile terminal 109 authorizes access for the user. In step S503, if the user cannot successfully enter the system, then the procedure returns to step S502. If the user successfully enters the system, then in step S504, the mobile terminal 109 inquires whether or not the user wants to upload and/or download data. If the user does not want to upload or download data, then the procedure proceeds directly to step S508 described below. Otherwise, in step S505, the mobile terminal 109 downloads data including a business schedule from the mobile commerce server 103, and/or uploads data on execution of commercial activities already completed to the executing data storing module 303 of the mobile commerce server 103. These download and upload operations can be performed individually and separately. If the mobile terminal 109 only uploads data, then the procedure proceeds directly to step S508 described below. If the mobile terminal 109 downloads data, then in step S506, when all the data have been downloaded, the mobile terminal 109 displays the downloaded data and a summary prepared by the user of items needed by the user for execution of commercial activities. The user compares the downloaded data with the needed items, and marks any outstanding needed items. Then, in step S507, the business schedule storing module 301 determines whether all the downloaded data are prepared having regard to the user's mark, if any. If the downloaded data are not prepared, then the procedure returns to step S505, and the outstanding wanted data are downloaded. If the downloaded data are prepared, then the procedure proceeds directly to step S508. In step S508, the actual commercial activities are performed, and the executing data storing module 303 records corresponding operations during the process of execution of the commercial activities. When the commercial activities are finished, in step S509 the business schedule storing module 301 determines whether all required visits to clients have been completed. If all required client visits have not been completed, then the procedure returns to step S508 and the sales representative continues to visit other clients. If and when all required client visits have been completed, then in step S510, the executing data storing module 303 collects and analyzes all client visit information on the business schedule, and generates a consolidated report for the sales representative to review.

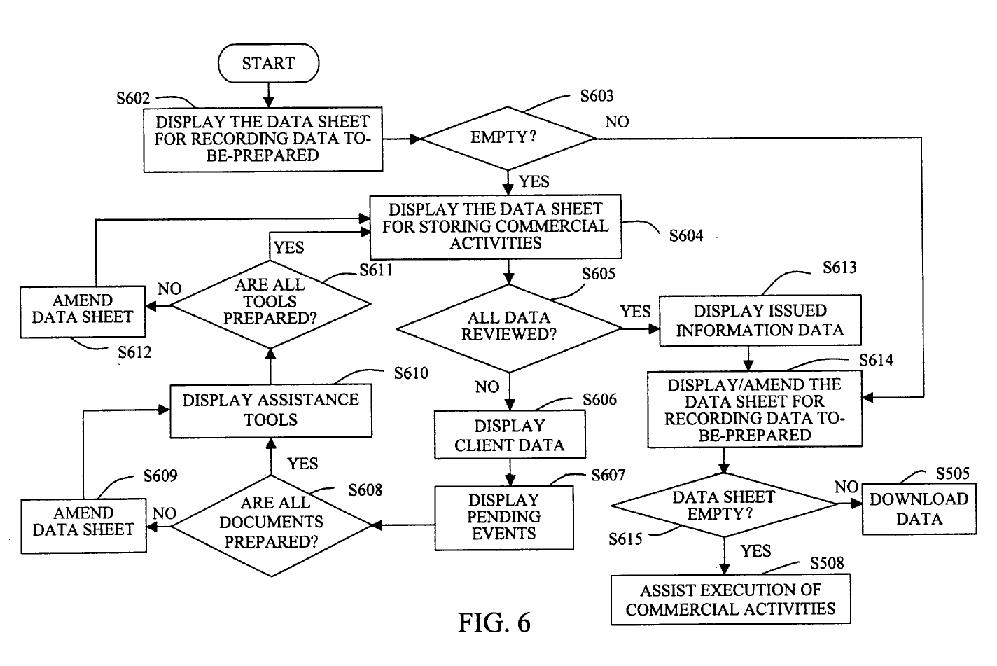

FIG. 6 is a flowchart of details of step S506 of FIG. 5, namely reviewing downloaded data. Firstly, in step S602, the data reviewing interface 405 displays the downloaded data sheet for recording data to-be-prepared 404. In step S603, the data reviewing interface 405 ascertains whether the data sheet for recording data to-be-prepared 404 is empty. If the data sheet for recording data to-be-prepared 404 is not empty, this indicates that it is ready to be checked by the sales representative, and the procedure proceeds directly to step S614 described below. If the data sheet for recording data to-be-prepared 404 is empty, this indicates that reviewing of all downloaded data by the sales representative needs to be checked for, and the procedure proceeds to step S604.

In step S604, the data reviewing interface 405 displays the data sheet for storing commercial activities 402, which shows commercial activity items such as clients to visit and events to execute. In step S605, the data reviewing interface 405 determines whether all data stored in the data sheet for storing commercial activities 402 have been earmarked as having been reviewed by the sales representative. If all said data have been so reviewed, the procedure proceeds directly to step S613 described below. Otherwise, the data reviewing interface 405 begins to review documents and assistance tools required for execution of commercial activities. In step S606, the data reviewing interface 405 displays client data corresponding to one commercial activity item requiring review. The client data include client basic data, client sales order data and accounts receivable. The client basic data includes client name, address, and phone number. In step S607, the data reviewing interface 405 displays the data sheet for storing pending events 401, which shows details of all pending events corresponding to the commercial activity item requiring review. In step S608, the sales representative inspects every pending event item, and ticks off any pending event item that contains documents that have not been prepared. If no pending event item is ticked off, the procedure proceeds directly to step S610 described below. Otherwise, in step S609, the data reviewing interface 405 adds the pending event items ticked off to the data sheet for recording data to-be-prepared 404. Then in step S610, the data reviewing interface 405 displays the data sheet for storing assistance tools 403, which shows details of all sales tools corresponding to the commercial activity item requiring review. In step S611, the sales representative inspects every assistance tool item, and ticks off any assistance tool item that contains tools that have not been prepared. If no assistance tool item is ticked off, the procedure returns to step S604 directly. Otherwise, in step S612, the data reviewing interface 405 adds the sales tool items ticked off to the data sheet for recording data to-be-prepared 404. Thereupon, the procedure returns to step S604.

In step S613, the data reviewing interface 405 displays information obtained from the issued information storing module 304. Such information reminds the sales representative about the enterprise's current news, including merchandise shortage notes, new sales strategies and newly promoted products. In step S614, the data reviewing interface 405 displays the data sheet for recording data to-be-prepared 404. The sales representative checks the data sheet for recording data to-be-prepared 404, and proceeds to prepare all unprepared documents and all unprepared assistance tools. When each unprepared document or assistance tool has been prepared, the sales representative ticks off the corresponding item in the data sheet for recording data to-be-prepared 404. The data reviewing interface 405 thereupon deletes the item from the data sheet for recording data to-be-prepared 404. The sales representative thus proceeds to prepare all unprepared documents and assistance tools with a view to rendering the data sheet for recording data to-be-prepared 404 completely empty. In step S507, the data reviewing interface 405 ascertains whether the data sheet for recording data to-be-prepared 404 is empty. If the data sheet for recording data to-be-prepared 404 is empty, the procedure proceeds to step S508 (see FIG. 5). Otherwise, the procedure proceeds to step S505 (see FIG. 5).

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

What is claimed is:

1. A system for reviewing data in a mobile terminal, the system comprising:
a client data storing module for storing data on clients; and
a pending event storing module connecting with the client data storing module and accessing data stored in the client data storing module;
the pending event storing module comprising a data sheet for storing commercial activities, a data sheet for storing pending events, a data sheet for recording data to-be-prepared, and a data reviewing interface, wherein:
the data reviewing interface links with the data sheet for recording data to-be-prepared and the data sheet for storing commercial activities, and displays data stored in the data sheet for recording data to-be-prepared, the data sheet for storing commercial activities, the data sheet for storing pending events, and the client data storing module; and
the data sheet for storing pending events links with the client data storing module, and accesses data stored in the client data storing module.

2. The system for reviewing data in a mobile terminal as claimed in claim 1, wherein the data reviewing interface provides the function of ticking off any one or more selected items of the data sheet for storing pending events, the data sheet for storing commercial activities and the data sheet for recording data to-be-prepared when the data stored in the data sheets are displayed on the data reviewing interface.

3. The system for reviewing data in a mobile terminal as claimed in claim 2, wherein the data reviewing interface further provides functions of adding items ticked off in the data sheet for storing pending events and the data sheet for storing commercial activities to the data sheet for recording data to-be-prepared.

4. The system for reviewing data in a mobile terminal as claimed in claim 2, wherein the data reviewing interface deletes items ticked off in the data sheet for recording data to-be-prepared.

5. A method for reviewing data in a mobile terminal, the method comprising the steps of:
displaying a data sheet for storing recording data to-be-prepared;
displaying a data sheet for storing pending events;
displaying a data sheet for storing commercial activities;
ticking off one or more selected items in the data sheets via a data reviewing interface;
adding items ticked off in the data sheet for storing commercial activities and the data sheet for storing pending events to the data sheet for recording data to-be-prepared; and
deleting items ticked off in the data sheet for recording data to-be-prepared.

6. The method for reviewing data in a mobile terminal as claimed in claim 5, further comprising the step of:
downloading data in accordance with items ticked off in the data sheet for recording data to-be-prepared.

7. A process of preparing a sales representative for visiting a client, comprising sequential steps of:
(1) displaying a data sheet for storing recording data to-be-prepared;
(2) displaying a data sheet for storing commercial activities, if said data sheet in step (1) is empty, or
(3) displaying/amending a data sheet for recording data to-be-prepared if said data sheet in step (1) is not empty;
(4) displaying a client data and displaying pending events if not all data have been reviewed after step (2);
(5) displaying issued information data sheet and joining step (3) if all data have been reviewed after step (2);
(6) displaying assistance tools if all documents are prepared after step (4); or
(7) amending data sheet before displaying assistance tools if not all documents are prepared after step (4);
(8) moving back to step (2) if not all tools are prepared after step (6); or
(9) amending data sheet before moving back to step (2) if not all tools are prepared after step (6).
